(19) United States
(12) Patent Application Publication
(10) Pub. No.: US 2013/0116803 A1
(43) Pub. Date: May 9, 2013

(54) MANAGING THE CARBON FOOTPRINT OF A STRUCTURE

(71) Applicants: Daniel J. Gmach, Palo Alto, CA (US); Tahir Cader, Liberty Lake, WA (US); Cullen E. Bash, Los Gatos, CA (US); Amip J. Shah, Santa Clara, CA (US); Ratnesh K. Sharma, Fremont, CA (US)

(72) Inventors: Daniel J. Gmach, Palo Alto, CA (US); Tahir Cader, Liberty Lake, WA (US); Cullen E. Bash, Los Gatos, CA (US); Amip J. Shah, Santa Clara, CA (US); Ratnesh K. Sharma, Fremont, CA (US)

(21) Appl. No.: 13/288,669

(22) Filed: Nov. 3, 2011

(51) Int. Cl. G05B 13/02

(52) U.S. Cl. 700/33

(57) ABSTRACT

Carbon footprint management for structures is disclosed. In an example, a method includes determining a value of a first carbon footprint of the structure when operated at an existing demand for a first time period, and comparing the value of the first carbon footprint to a value of a prorated carbon cap of the structure for the first time period. If the first carbon footprint is less than or equal to the prorated carbon cap, the structure is operated for a second time period according to the existing demand or other demand that keeps a second carbon footprint of the structure below a prorated carbon cap for the second time period. Otherwise, the demand is adjusted to bring the second carbon footprint to approximate the prorated carbon cap for the second time period, and the structure is operated according to the adjusted demand for the second time period.

### BACKGROUND

Significant research is underway to develop technologies that reduce energy use and the environmental impact of structures. The carbon footprint of a structure is a measure of the amount of carbon dioxide (CO₂) emissions produced by the energy (such as from fossil-fuel or other CO₂-equivalent) used to operate equipment, machinery and other types of technology in the structure. The carbon footprint has units of tons or kg of carbon dioxide equivalent. In some regions, emissions regulations impose a cap, i.e., a maximum allowable amount, on the carbon footprint of a structure. Fines or other types of penalties may be imposed if the carbon footprint of a structure is exceeded. In some arenas, companies participate in programs to voluntarily set and meet carbon caps.

### BRIEF DESCRIPTION OF THE DRAWINGS

FIG. 1 is a block diagram of an example resource management system for a structure.

FIG. 2 is a block diagram of another example resource management system for a structure.

FIG. 3 is a flowchart illustrating example operations for managing the carbon footprint of a structure.

FIG. 4 is a flowchart illustrating another example of operations for managing the carbon footprint of a structure.

FIG. 5 illustrates a block diagram of a computing apparatus configured to implement the method depicted in FIG. 3 or FIG. 4.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

The increased concern about the carbon footprint of a structure is driven by a combination of legislation, cost penalties associated with violating legislation, and social pressure to show a “greener” footprint. The efforts to find alternative energy sources have resulted in the development of different varieties of low carbon sources, including green and renewable energy technologies.

Described herein are innovative methods and systems that facilitate management of the carbon footprint of a structure. The structure can be any building, including a data center, a commercial building, an office building, a fabrication facility, a factory or a residence. Buildings consume about 40% of the total electricity generated. Hence, a system and method for managing the carbon footprint of a structure can help reduce energy use and the environmental impact of the structure. Given the increasing efforts to limit the carbon footprints of structures, any success at managing the carbon footprint could provide a significant advantage.

As used herein, the term “data center” is intended to be broadly defined, and may include anything that provides the infrastructure to operate electronics equipment, including a “permanent” facility or a modular or mobile data center. It is estimated that the information and communication technology sector is responsible for about two percent of global energy use and carbon emissions. Much of this is due to the energy consumption of data centers. Other types of structures that incorporate information and communication technology, including office and commercial buildings, are also estimated to contribute to global energy use and carbon emissions.

The level of demand on a structure contributes to its carbon footprint. The type of demand depends on the type of structure. In a non-limiting example where the structure is a commercial building, the demand can be due to heating or cooling systems, lighting and display in the structure, IT and other computer-based equipment used in the structure, and types of transport equipment. In a non-limiting example where the structure is a residence, the demand can be due to television, other video and audio equipment, heating or cooling systems, major appliances, lighting systems, IT and other computer-based equipments used in the structure. In a non-limiting example where the structure is an office building, the demand can be due to heating or cooling systems, lighting systems, IT and other computer-based equipment (including printers and fax machines), and communication systems.

In a non-limiting example where the structure is a data center, the demand can be due to heating or cooling systems, lighting systems, IT equipment used in the structure, and various types of sensor and transport equipments used in the structure. Virtualization technology can be used to consolidate workload and facilitate information technology (IT) utilization and reduce IT power consumption. For data centers, cooling technologies, such as, water-side economizers, and the direct use of outside air further help facilitate cooling efficiency. On the supply side, renewable energy and distributed power supply management are being developed to reduce environment impact and cost.

The systems and methods herein allow a user to meet carbon caps set, for example, voluntarily by an entity or based on legislation. Where the carbon caps are set by legislation, systems and methods allow a user to meet carbon caps and avoid costly penalties. In the event that the management of the carbon footprint of the structure using its infrastructure components is insufficient, the disclosure also described methods and systems that incorporate renewable energy technologies in a cost-effective manner. The power consumption of the structure also may be managed.

In an example, the systems and methods disclosed herein can be used to generate a management plan for managing the carbon footprint of a structure through an integrated analysis of the carbon emissions of the structure. The power usage of the structure also may be managed. In an example, if legislation mandates that a corporation meet a certain carbon footprint, the company may decide to set a carbon cap for its structure. In an example, the structure is a data center, which can present large carbon footprint. The carbon footprint of a structure (including a data center) and its ability to meet a given carbon cap can be related to its IT load, the power consumption of the supporting facility (power & cooling), and its power supply side infrastructure. The power supply side can include a micro grid with on-site renewable energy sources and energy storage systems, as well as a possibility of sourcing low carbon sources, including “green” energy, from energy providers. In an example, the ability to control the power consumption of the machinery and equipment of the structure, including the IT equipment, are factors in being able to control carbon footprint, and in turn meet a carbon cap. In an example where the structure is a data center, described herein are systems and methods that use controllers to manage IT power consumption in relation to carbon footprint and carbon caps that have been set (including carbon caps set by an entity, a corporation, or by legislation).

Systems and methods disclosed herein for managing the carbon footprint of a structure are applicable to structures having infrastructure components. The infrastructure components may include information technology (IT) equipment, such as, but not limited to servers, network switches, routers, firewalls, intrusion detection systems, intrusion prevention systems, hard disks, monitors, power supplies, and other components typically found in computer networking environments. The infrastructure may also include facility equipment, such as, but not limited to facility power supply equipment, air conditioning systems, air moving systems, water chillers, and other equipment typically found in operating computer networking environments. In one regard, the structure comprises at least one computer room or container, such as, but not limited to an IT data center that houses the infrastructure components. In addition, throughout the present disclosure, the term “managing” is intended to encompass either or both of designing and operating the structure.

Where a system and method herein facilitates a structure to be operated below its carbon cap, revenue may be generated from trading of any excess carbon credits in any available emissions trading system.

In an example, the systems and methods herein also uses power capping to manage power consumption in relation to carbon footprint and carbon caps that have been set. Many different power-capping mechanisms are applicable. The power cap can be set on a per-device or per-equipment basis. As non-limiting examples, the equipment can be IT equipment or factory equipment; the devices can be household appliances. For example, the power cap of a structure such as a data center can be set on a per-server basis. The specific device or equipment (e.g., the server) that is subject to the power cap would change its operation to meet the desired power usage level. The power cap can be set based on a connected cluster of devices or equipment. For example, the power cap of a structure such as a data center can be set on a per-rack level (for racks of server), so it changes the operations of the rack. The power cap also can be set on a group level (groups of devices or equipment in a structure). When a power cap is set, the power draw from the device or equipment can be monitored machine to determine if it is meeting its power cap. As described below, controller can be used to set the power cap on the per-device or per-equipment level, on the cluster level, or on the group level. As is pertinent, each device or equipment is run to meet its set point (possibly at the expense of performance). In an example, for a data center, if it is not possible to meet service level agreements with the power caps imposed, it may be considered to transfer workload to other data centers.

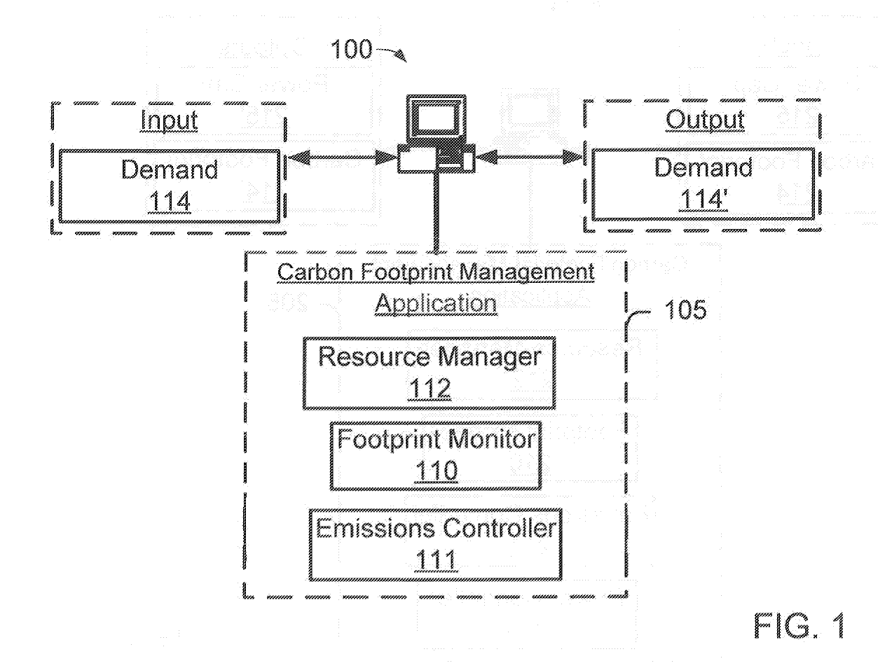

FIG. 1 is a block diagram of an example carbon footprint management system 100. The carbon footprint management system 100 may be implemented in program code, including but not limited to, computer software, web-enabled or mobile applications or “apps”, so-called “widgets,” and/or embedded code, including firmware. Although the program code is illustrated in FIG. 1 as including a number of components or modules, the program code is not so limited. The program code may include additional components, modules, routines, subroutines, etc. In addition, one or more functions may be combined into a single component or module.

Carbon footprint management system 100 includes a carbon footprint management application 105. Carbon footprint management application 105 includes carbon footprint monitor 110 and an emissions controller 111 operatively associated with the carbon footprint monitor 110. The carbon footprint monitor 110 is operatively associated with an input of demand 114 for the demand of the structure. The carbon footprint monitor 110 determines a value of the carbon footprint of the structure when operated at an amount of demand 114 for a certain time period. A resource manager 112 is operatively associated with the carbon monitor 110 and the emissions controller 111. The emissions controller interface 111 configures output of a demand 114′ based on a comparison of the determined value of the carbon footprint to a value of a prorated carbon cap of the structure for the certain time period.

The resource manager 112 evaluates multiple available resources, as well as multiple infrastructure component and facilities management policies of the structure to enable the evaluation and comparison of various alternative approaches to supply the structure with resources for meeting the demand 114′. The resource manager 112 configures output of the emissions controller 111 to operate the structure for a time period according to demand 114′. The integrated analysis may be employed to identify a combination of the infrastructure component operations and the supply of resources that facilitate meeting carbon emission levels to achieve the desired carbon footprint. A plurality of combinations may be evaluated to identify a substantially optimized combination.

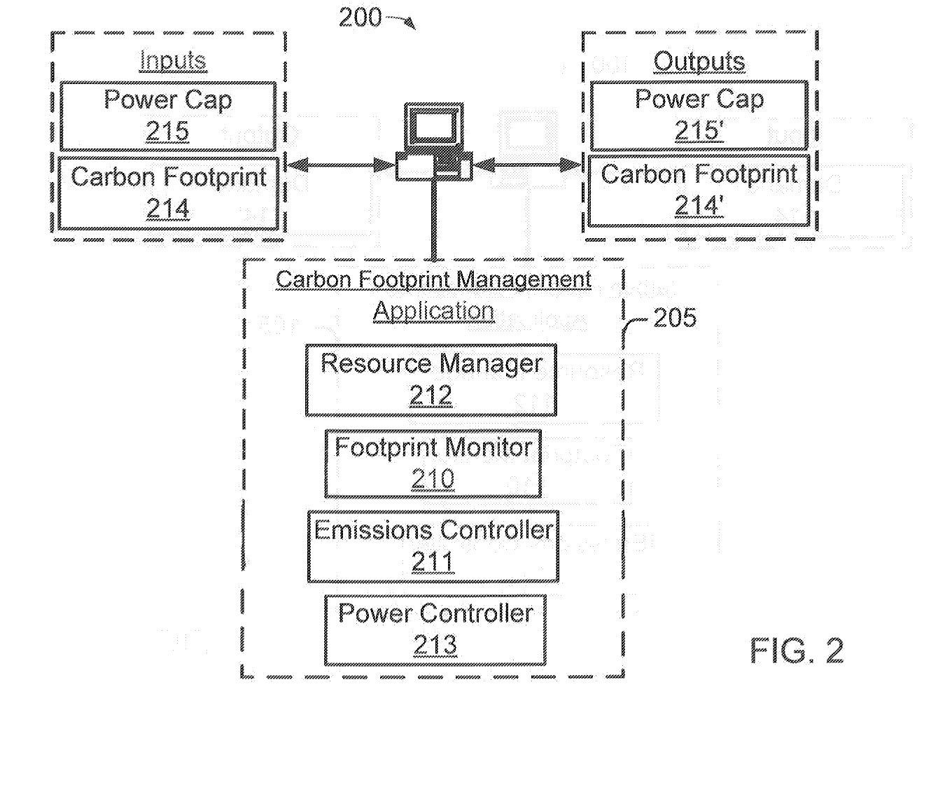

FIG. 2 is a block diagram of another example carbon footprint management system 200. The carbon footprint management system 200 also may be implemented in program code, including but not limited to, computer software, web-enabled or mobile applications or “apps”, so-called “widgets,” and/or embedded code such as firmware. The program code is illustrated in FIG. 2 as including a number of components or modules, however, the program code is not so limited. The program code may include additional components, modules, routines, subroutines, etc. In addition, one or more functions may be combined into a single component or module.

Carbon footprint management system 200 includes a carbon footprint management application 205. Carbon footprint management application 205 includes a carbon footprint monitor 210 and an emissions controller 211 operatively associated with the carbon footprint monitor 210. The carbon footprint monitor 210 is operatively associated with an input of demand 214 for the demand of the structure. The carbon footprint monitor 210 determines a value of the carbon footprint of the structure when operated at an amount of demand 214 for a certain time period. Carbon footprint management system 200 also includes a power controller 213 operatively associated with an input of power 215 for the power cap of the structure. A resource manager 212 is operatively associated with the carbon monitor 210, the emissions controller 211, and the power controller 213. The power controller 213 configures output of a power cap 215′ based on a comparison of the determined value of the carbon footprint to a value of a prorated carbon cap of the structure for the certain time period. The emissions controller interface 211 configures output of a demand 214′ that meets the power cap 215′.

The resource manager 212 evaluates multiple available resources, as well as multiple infrastructure component and facilities management policies of the structure to enable the evaluation and comparison of various alternative approaches to supply the structure with resources for meeting the demand 214′. The resource manager 212 configures output of the emissions controller 211 to operate the structure for a time period according to demand 214′. The integrated analysis may be employed to identify a combination of the infrastructure component operations and the supply of resources that facilitate meeting carbon emission levels to achieve the desired carbon footprint. A plurality of combinations may be evaluated to identify a substantially optimized combination.

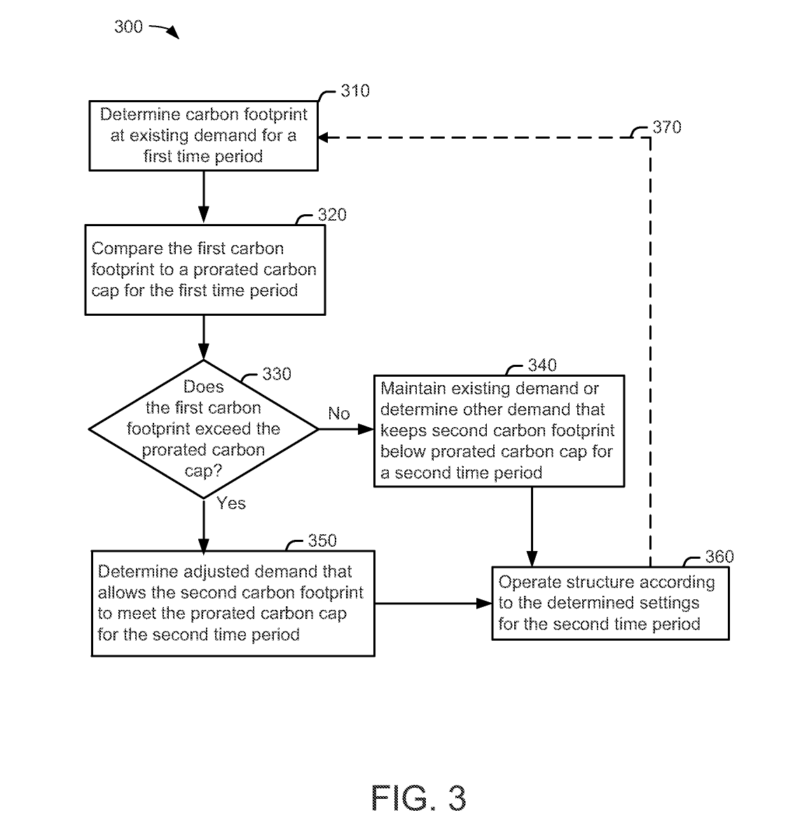

FIG. 3 is a flowchart illustrating example operations for managing the carbon footprint of a structure. Operations 300 may be embodied as logic instructions (e.g., firmware) on one or more computer-readable media. When executed by a processor, the logic instructions implement the described operations. In an example implementation, the components and connections depicted in the figures may be utilized.

In operation 310, a first carbon footprint is determined for the structure at an existing demand on the structure for a first time period. It is noted that the terms “determine,” “determined,” and “determining” are intended to be construed sufficiently broadly as to include receiving input from an outside source (e.g., user input and/or electronic monitoring), and may also include additional processing and/or formatting of various data from one or more sources. The first time period can be a week, a month, a quarter (i.e., a three-month period), a half year, or three quarters of a year, or more.

In an example where the structure is a data center, the demand can be based on the IT workload. A value of a measure of the first carbon footprint of the structure can be determined while the structure is being operated at an existing IT workload for the first time period.

In operation 320, the first carbon footprint is compared to a prorated carbon cap for the first time period. The prorated carbon cap for the time period is determined based on an overall carbon cap set for the structure, whether by legislation or voluntarily.

In an example, there is a set annual maximum allowable carbon footprint from the structure. In order to meet this annual carbon footprint, a quarterly carbon footprint target, and along with that, a quarterly carbon cap, can be set. In an example, the carbon cap may be calculated and monitored on a daily basis in order to meet the quarterly carbon footprint target (or the maximum allowable carbon footprint for the year).

In operation 330, it is determined whether the first carbon footprint determined in operation 310 exceeds the carbon cap for the first time period. For example, the calculated first carbon footprint for the structure at the existing level of demand can be compared it to a value of a carbon cap of the structure for the first time period to determined whether the carbon cap for the time period is going to be met or exceeded.

If the carbon footprint determined in operation 310 does not exceeds the carbon cap for the first time period, operation 340 is performed for a second time period that is subsequent to the first time period. The second time period can be a week, a month, a quarter (i.e., a three-month period), a half year, or three quarters of a year, or more. The second time period can be the same as, or different from, the first time period. In operation 340, the structure can be maintained at the existing demand for the second time to provide the second carbon footprint. Alternatively, the structure can be maintained at some other level of demand which is determined as a level of demand that keeps the second carbon footprint below the prorated carbon cap for the second time period.

In operation 360, the structure is operated according to the determined settings for the second time period (which is subsequent to the first time period). If the carbon footprint determined in operation 310 does not exceeds the carbon cap for the first time period, then the determined settings for the operation of the structure in block 360 is either the existing demand or the other level of demand that keeps the second carbon footprint below the prorated carbon cap for the second time period. The carbon emissions can be monitored during operation of the structure for the second time period.

If the carbon footprint determined in operation 310 does exceed the carbon cap for the first time period, operation 350 is performed for the second time period. In operation 350, an adjusted demand is determined that allows the second carbon footprint to meet the prorated carbon cap for the second time period. The structure is operated in block 360. In operation 360, the determined settings for the second time period is the adjusted demand that brings the second carbon footprint to meet the prorated carbon cap for the second time period. The carbon emissions also can be monitored.

In an example, the structure is a data center. If the first carbon footprint determined in 330 is greater than the prorated carbon cap for the first time period, in operation 350, the IT workload is determined that allows the carbon cap to be met. The IT workload of the structure is adjusted to bring the carbon footprint to approximate the value of the prorated carbon cap for the second time period.

In an example, data including historic utilization, historical weather, and resource availability is used to project the IT workload under which the carbon cap for the quarter can be met. The adjusted IT workload target for the second time period is set based on the projected IT workload. If the IT demand of the structure causes it to exceed the maximum carbon footprint, IT workload can be shifted to a different facility.

In an example where the structure is a data center, if IT demand is projected to cause the carbon cap to be exceeded, workload can be shifted to other data centers. The IT workload of the data center can be adjusted to meet the requirements of the service level agreements of the data center.

In an example where the structure is a data center, the IT workload can be adjusted to meet the requirements of service level agreements of the data center.

In an example of a data center, if the first carbon footprint exceeds the prorated carbon cap for the first time period, the power cap of the structure can be adjusted to bring the second carbon footprint to meet the prorated carbon cap for the second time period. The IT workload can be adjusted to meet the adjusted power cap. The structure can be operated (in operation 360) according to the adjusted IT workload and adjusted power cap for the second time period.

In an example operation 360, the second carbon footprint and the power cap of the structure can be monitored during operation according to an existing IT workload or an adjusted IT workload for the second time period. The carbon emissions also can be monitored.

In an example, the power cap may be set internally (e.g., based on an internal power usage policy for reducing consumption and/or budget reasons). In another example, the power cap may also be set externally (e.g., based on mandates by the utility company, regulations, and so forth). The power cap may also be negotiated, e.g., between the operator of the structure (including a data center operator or among multiple data center operators) and/or the utility company or various regulatory bodies.

The structure may not meet its carbon cap based on adjusting the demand. In this case, low carbon sources, including alternative and “green” power, can be used. Furthermore, power capping or workload shifting can incur higher costs, such as penalty costs for not achieving service level agreements or costs for transferring IT workload data to other facilities (such as other data centers). A model based on economic parameters can be used to determine when power capping or IT workload shifting can be applied and when other green power sources should be considered.

As indicated in FIG. 3, the operations can be repeated (see operation 370) for continual monitoring of the carbon footprint of the structure. For example, the level of the demand that produced the second carbon footprint during the second time period becomes the input level of demand for another time period subsequent to the second time period. The level of demand in the second time period becomes the existing demand in operation 310 when the operations are repeated.

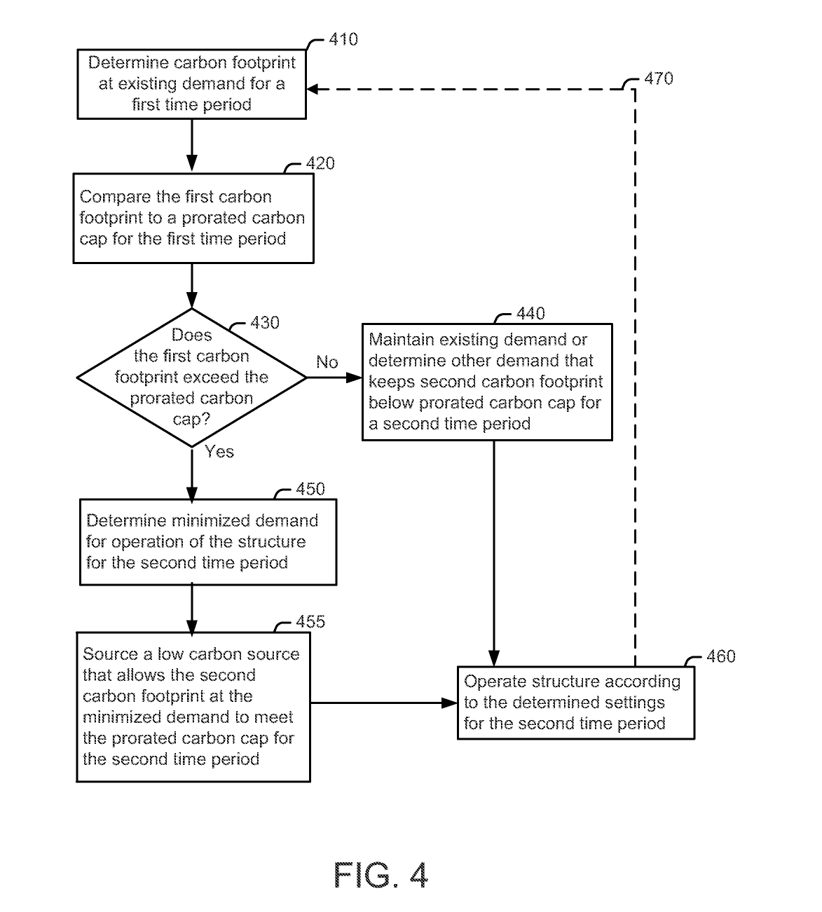

FIG. 4 illustrates a non-limiting example of such an approach. The approach is applicable to a structure (including a data center) that has access to low carbon sources of energy. This gives the structure the capability to source low carbon sources, including “green” power. Non-limiting examples of “green” power are renewable energy sources and other less carbon-intensive energy sources, including wind power, solar energy, geothermal energy, water, and biofuels. The “green” power can be sourced from a micro-grid. For a given reason (economic, social, and/or legislative), a structure may have a specific carbon footprint that has to be met. In an example, in order to meet its annual footprint, a quarterly carbon footprint target can be, and along with that, a quarterly carbon cap. The carbon cap of a structure can be calculated and monitored on a daily basis in order to meet its target for the quarter (or year).

FIG. 4 is a flowchart illustrating another example of operations for managing the carbon footprint of a structure. Operations 400 may be embodied as logic instructions (e.g., firmware) on one or more computer-readable media. When executed by a processor, the logic instructions implement the described operations. In an example implementation, the components and connections depicted in the figures may be utilized.

In operation 410, a first carbon footprint is determined for the structure at an existing demand on the structure for a first time period. The first time period can be a week, a month, a quarter (i.e., a three-month period), a half year, or three quarters of a year, or more.

In an example where the structure is a data center, the demand can be based on the IT workload. A value of a measure of the first carbon footprint of the structure can be determined while the structure is being operated at an existing IT workload for the first time period.

In operation 420, the first carbon footprint is compared to a prorated carbon cap for the first time period. The prorated carbon cap for the time period is determined based on an overall carbon cap set for the structure, whether by legislation or voluntarily.

In an example, there is a set annual maximum allowable carbon footprint from the structure. In order to meet this annual carbon footprint, a quarterly carbon footprint target, and along with that, a quarterly carbon cap, can be set. In an example, the carbon cap may be calculated and monitored on a daily basis in order to meet the quarterly carbon footprint target (or the maximum allowable carbon footprint for the year).

In operation 430, it is determined whether the first carbon footprint determined in operation 410 exceeds the carbon cap for the first time period. For example, the calculated first carbon footprint for the structure at the existing level of demand can be compared it to a value of a carbon cap of the structure for the first time period to determined whether the carbon cap for the time period is going to be met or exceeded.

If the carbon footprint determined in operation 410 does not exceeds the carbon cap for the first time period, operation 440 is performed for a second time period that is subsequent to the first time period. The second time period can be a week, a month, a quarter (i.e., a three-month period), a half year, or three quarters of a year, or more. The second time period can be the same as, or different from, the first time period. In operation 440, the structure can be maintained at the existing demand for the second time to provide the second carbon footprint. Alternatively, the structure can be maintained at some other level of demand which is determined as a level of demand that keeps the second carbon footprint below the prorated carbon cap for the second time period.

In operation 460, the structure is operated according to the determined settings for the second time period (which is subsequent to the first time period). If the carbon footprint determined in operation 410 does not exceeds the carbon cap for the first time period, then the determined settings for the operation of the structure in block 460 is either the existing demand or the other level of demand that keeps the second carbon footprint below the prorated carbon cap for the second time period. The carbon emissions can be monitored during operation of the structure for the second time period.

If the carbon footprint determined in operation 410 does exceed the carbon cap for the first time period, operation 450 is performed for the second time period. In operation 450, a minimized demand is determined that reduces the second carbon footprint of the structure. In operation 455, the availability of a low carbon source is determined that allows the prorated carbon cap to be met at the minimized demand for the second time period. Much of the low carbon sources, including “green” power, such as renewable energy sources and other less carbon-intensive energy sources (including energy from a micro-grid), are developed to reduce environment impact and cost.

The structure is operated (in operation 460) according to the minimized demand and the sourced low carbon source (the determined settings) for the second time period. The second carbon footprint can be monitored during operation for the second time period. The carbon emissions also can be monitored.

In an example, if the carbon footprint determined in 420 is greater than the carbon cap for the first time period, in operation 450, a minimized power cap can be set that is economical and viable for operation of the structure. The IT workload is adjusted to a minimized IT workload that meets the minimized power cap. The structure is operated (in operation 460) according to the minimized power cap, the minimized demand, and the low carbon source for the second time period.

As indicated in FIG. 4, the operations can be repeated (see operation 470) for continual monitoring of the carbon footprint of the structure. For example, the level of the demand that produced the second carbon footprint during the second time period can be the input level of demand for another time period that is subsequent to the second time period. That is, the level of demand in the second time period becomes the existing demand in operation 410 when the operations are repeated.

In an example where the structure is a data center, if IT workload is projected to cause the carbon cap to be exceeded, workload can be shifted to another data center. The IT workload of the data center can be adjusted to meet the requirements of the service level agreements of the data center.

In an example, a power management scheme can be introduced where potential “costs” are considered to determine if the operations are economical. The “costs” include the cost of buying power from low carbon source, including a grid (such as a micro-grid), the cost of potential downtime from reliance on an intermittent on-site power source, the cost of violating a carbon cap, and the cost of reducing power consumption by allowing for increased IT operating temperatures.

A system and method herein can include an assessment engine that is used to compare the costs. The assessment engine can implement a number of different cost-reduction solutions based on the assessment. For example, the assessment engine can choose the lowest cost low carbon source of energy for managing a data center while meeting all service level agreements. In another example, the assessment engine can dynamically price services with different service level agreements, so that a customer with a service level agreement that requires a higher-carbon source of power (such as a grid) may be required to pay a higher price, thus offsetting the added cost of potentially violating a carbon cap. In another example, the assessment engine can schedule workload or modify workload in a manner where service level agreements are prioritized (e.g., based on cost of penalty) until a time where the carbon caps may no longer be in danger of being violated. In another example, each (or all) of the “costs” could be compared to the potential benefit available from selling carbon credits on an applicable trading market if the carbon footprint falls below the carbon cap.

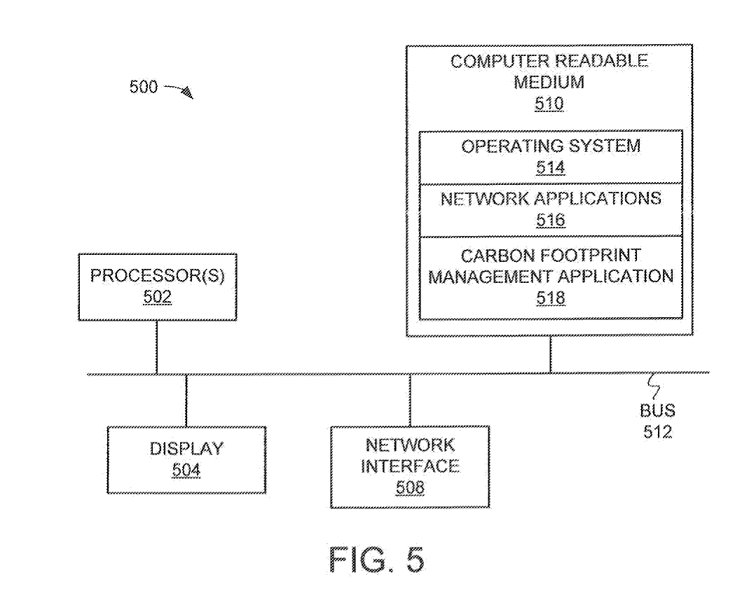

Turning now to FIG. 5, there is shown a schematic representation of a computing device 400 that may be used as a platform for implementing or executing the processes depicted in FIGS. 3 and 4, according an example. The device 500 includes at least one processor 502, such as a central processing unit; at least one display device 504, such as a monitor; at least one network interface 508, such as a Local Area Network LAN, a wireless 802.11x LAN, a 3G mobile WAN or a WiMax WAN; and a computer-readable medium 510. Each of these components is operatively coupled to at least one bus 512. For example, the bus 512 may be an EISA, a PCI, a USB, a FireWire, a NuBus, or a PDS.

The computer readable medium 510 may be any suitable medium that participates in providing instructions to the processor 502 for execution. For example, the computer readable medium 510 may be memory, including non-volatile media, such as an optical or a magnetic disk; volatile media memory; and transmission media, such as coaxial cables, copper wire, and fiber optics. Transmission media may also take the form of acoustic, light, or radio frequency waves. The computer readable medium 510 has been depicted as also storing other machine readable instruction applications, including word processors, browsers, email, Instant Messaging, media players, and telephony machine readable instructions.

The computer-readable medium 510 has also been depicted as storing an operating system 514, such as Mac OS, MS Windows, Unix, or Linux; network applications 516; and a carbon footprint management application 518. The operating system 514 may be multi-user, multiprocessing, multitasking, multithreading, real-time and the like. The operating system 514 may also perform basic tasks, such as recognizing input from input devices, such as a keyboard or a keypad; sending output to the display 504 and the design tool 506; keeping track of files and directories on medium 410; controlling peripheral devices, such as disk drives, printers, image capture device; and managing traffic on the at least one bus 512. The network applications 416 include various components for establishing and maintaining network connections, such as machine readable instructions for implementing communication protocols including TCP/IP, HTTP, Ethernet, USB, and FireWire.

The carbon footprint management application 518 provides various components with machine executable instructions for providing computing services to users, as described above. In certain examples, some or all of the processes performed by the application 518 may be integrated into the operating system 514. In certain examples, the processes may be at least partially implemented in digital electronic circuitry, or in computer hardware, machine executable instructions (including firmware and/or software) or in any combination thereof.

What has been described and illustrated herein are various examples of the disclosure along with some of their variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

In addition to the specific embodiments explicitly set forth herein, other aspects and embodiments will be apparent to those skilled in the art from consideration of the specification disclosed herein. It is intended that the specification and illustrated embodiments be considered as examples only.

What is claimed is:

1. A method of managing carbon footprint of a structure, comprising:
determining a value of a first carbon footprint of the structure when operated at an existing demand for a first time period;
comparing the value of the first carbon footprint to a value of a prorated carbon cap of the structure for the first time period; and
if the first carbon footprint is less than or equal to the prorated carbon cap for the first time period, operating the structure for a second time period subsequent to the first time period according to the existing demand or other demand that keeps a second carbon footprint of the structure below a prorated carbon cap for the second time period; or
if the first carbon footprint exceeds the prorated carbon cap for the first time period,
adjusting the demand of the structure to bring the second carbon footprint to approximate the value of the prorated carbon cap for the second time period, and
operating the structure according to the adjusted demand for the second time period.

2. The method of claim 1, wherein the structure is a data center, a commercial building, an office building, a fabrication facility, a factory or a residence.

3. The method of claim 2, wherein the structure is a data center, and wherein the demand is an IT workload of the data center.

4. The method of claim 3, wherein the IT workload of the structure is adjusted to meet the requirements of service level agreements of the data center.

5. The method of claim 3, comprising, if the first carbon footprint exceeds the prorated carbon cap for the first time period:
adjusting a power cap of the structure to bring the second carbon footprint to approximate the value of the prorated carbon cap for the second time period;
adjusting the IT workload to meet the adjusted power cap; and
operating the structure according to the adjusted IT workload and adjusted power cap for the second time period.

6. The method of claim 1, further comprising monitoring the second carbon footprint of the structure during operation for the second time period.

7. A method of managing carbon footprint of a structure, comprising:
determining a value of a first carbon footprint of the structure operating at an existing demand for a first time period;
comparing the value of the first carbon footprint to a value of a prorated carbon cap of the structure for the first time period; and
if the first carbon footprint is less than or equal to the prorated carbon cap for the first time period, operating the structure for a second time period subsequent to the first time period according to the existing demand or other demand that keeps a second carbon footprint of the structure below a prorated carbon cap for the second time period; or
if the first carbon footprint exceeds the prorated carbon cap for the first time period:
adjusting the demand of the structure to a minimized demand for operation of the structure;
sourcing a low carbon source to bring the second carbon footprint to approximate the value of the prorated carbon cap for the second time period; and
operating the structure according to the adjusted demand and the sourced low carbon source for the second time period.

8. The method of claim 7, further comprising monitoring the second carbon footprint of the structure during operation for the second time period.

9. The method of claim 7, wherein the structure is a data center, a commercial building, an office building, a fabrication facility, a factory or a residence.

10. The method of claim 9, wherein the structure is a data center, and wherein the demand is an IT workload of the data center.

11. The method of claim 10, wherein the IT workload of the structure is adjusted to meet the requirements of service level agreements of the data center.

12. The method of claim 10, comprising, if the first carbon footprint exceeds the prorated carbon cap for the first time period:
adjusting a power cap of the structure to bring the second carbon footprint to a minimized power cap for the second time period;
adjusting the IT workload to a minimized IT workload that meets the minimized power cap;
sourcing a low carbon source to bring the second carbon footprint to approximate the value of the prorated carbon cap for the second time period; and
operating the structure according to the adjusted IT workload, the adjusted power cap and the sourced low carbon source for the second time period.

13. The method of claim 7, wherein the low carbon source is wind power, solar energy, geothermal energy, water power, biofuels or a micro-grid.

14. A carbon footprint management system for a structure, the system comprising:
a memory for storing computer executable instructions; and
a processing unit for accessing the memory and executing the computer executable instructions, the computer executable instructions comprising:
a carbon footprint monitor;
an emissions controller operatively associated with the carbon footprint monitor; and
a resource manager operatively associated with the carbon monitor and emissions controller;
wherein the carbon footprint monitor determines a value of a first carbon footprint of the structure when operated at an existing demand for a first time period;
wherein the carbon footprint management system compares the value of the first carbon footprint to a value of a prorated carbon cap of the structure for the first time period;
wherein, if the first carbon footprint is less than or equal to the prorated carbon cap for the first time period, the resource manager configures output of the emissions controller to operate the structure for a second time period subsequent to the first time period according to the existing demand or other demand that keeps a second carbon footprint of the structure below a prorated carbon cap for the second time period; and
wherein, if the first carbon footprint exceeds the prorated carbon cap for the first time period, the resource manager configures output of the emissions controller to:
adjust the demand of the structure to bring the second carbon footprint to approximate the value of the prorated carbon cap for the second time period; and
operate the structure for the second time period according to the adjusted demand.

15. The carbon footprint management system of claim 14, wherein the structure is a data center, a commercial building, an office building, a fabrication facility, a factory or a residence.

16. The carbon footprint management system of claim 15, wherein the structure is a data center, and wherein the demand is an IT workload.

17. The carbon footprint management system of claim 16, further comprising a power controller, wherein, if the first carbon footprint exceeds the prorated carbon cap for the first time period, the power controller adjusts a power cap of the structure to bring the second carbon footprint to approximate the value of the prorated carbon cap for the second time period; and
the resource manager configures output of the emissions controller to:
adjust the IT workload to meet the adjusted power cap; and
operate the structure according to the adjusted IT workload and adjusted power cap for the second time period.

18. The carbon footprint management system of claim 14, wherein the carbon footprint management system monitors the second carbon footprint of the structure during operation for the second time period.

19. A carbon footprint management system for a structure, the system comprising:
a memory for storing computer executable instructions; and
a processing unit for accessing the memory and executing the computer executable instructions, the computer executable instructions comprising:
a carbon footprint monitor;
an emissions controller operatively associated with the carbon footprint monitor; and
a resource manager operatively associated with the emissions controller and the carbon footprint monitor;
wherein the carbon footprint monitor determines a value of a first carbon footprint of the structure when operated at an existing demand for a first time period;
wherein the carbon footprint management system compares the value of the first carbon footprint to a value of a prorated carbon cap of the structure for the first time period;
wherein, if the first carbon footprint is less than or equal to the prorated carbon cap for the first time period, the resource manager configures output of the emissions controller to operate the structure for a second time period subsequent to the first time period according to the existing demand or other demand that keeps a second carbon footprint of the structure below a prorated carbon cap for the second time period; and
wherein, if the carbon footprint exceeds the prorated carbon cap for the first time period, the resource manager configures output of the emissions controller to:
adjust the demand of the structure to a minimized demand for operation of the structure;
source a low carbon source to bring the second carbon footprint to approximate the prorated carbon cap for the second time period; and
operate the structure according to the adjusted demand and the sourced low carbon source for the second time period.

20. The carbon footprint management system of claim 19, wherein the structure is a data center, a commercial building, an office building, a fabrication facility, a factory or a residence.

21. The carbon footprint management system of claim 20, wherein the structure is a data center, and wherein the demand is an IT workload.

22. The carbon footprint management system of claim 21, further comprising a power controller, wherein, if the first carbon footprint exceeds the prorated carbon cap for the first time period, the power controller adjusts a power cap of the structure to a minimized power cap for operation of the structure; and
the resource manager configures output of the emissions controller to:
adjust the IT workload to a minimized IT workload that meets the minimized power cap; and
operate the structure according to the adjusted IT workload, minimized power cap, and the sourced low carbon source for the second time period.

23. The method of claim 19, wherein the low carbon source is wind power, solar energy, geothermal energy, water power, biofuels or a micro-grid.
